(19) United States
(12) Patent Application Publication
(10) Pub. No.: US 2015/0015598 A1
(43) Pub. Date: Jan. 15, 2015

(54) ACCURATE PAINT COLOR REPRODUCTION ON DIGITAL IMAGES

(71) Applicant: MDI TOUCH, INC., Fremont, CA (US)

(72) Inventor: Mark E. Lichman, Fremont, CA (US)

(21) Appl. No.: 14/325,194

(22) Filed: Jul. 7, 2014

Related U.S. Application Data
(60) Provisional application No. 61/844,060, filed on Jul. 9, 2013.

(51) Int. Cl. G06T 11/00

(52) U.S. Cl. CPC G06T 11/001
USPC 345/594

(57) ABSTRACT

Technology is disclosed herein for accurate paint color reproduction on digital images. A method according to the technology identifies a computerized color representation closely corresponding to the paint color swatch number of interest from a color sample database. The method applies the identified computerized color representation to the relational function to generate a paint color representation adjusted by an ambient light condition extracted from the area of interest in the image. Then, the method reproduces the paint color representation adjusted by the ambient light condition on the area of interest in the image.

### PRIORITY CLAIM AND RELATED APPLICATION

This application claims to the benefit of U.S. Provisional Patent Application No. 61/844,060, entitled “ACCURATE PAINT COLOR REPRODUCTION ON DIGITAL IMAGES”, which was filed on Jul. 9, 2013, which is incorporated by reference herein in its entirety.

This application relates to U.S. patent application Ser. No. 14/010,359, entitled “METHOD AND APPARATUS FOR RECOGNIZING POLYGON STRUCTURES IN IMAGES”, which was filed on Aug. 26, 2013, which is incorporated by reference herein in its entirety.

### FIELD OF THE INVENTION

This invention relates generally to method and apparatus for image processing, and in particular to paint color reproduction on digital images.

### BACKGROUND

Technology advances have enabled the practical commercialization of increasingly sophisticated portable devices, such as tablet PCs (including the Apple iPad), and smartphones. Smartphones, in particular, are mobile phones offering advanced computing capabilities and connectivity, which may be thought of as handheld computers integrated within a mobile telephone. Smartphones are particularly characterized in that the user is able to install and run a wide range of advanced applications, based on sophisticated operating system software that provides a platform for application developers. Popular smartphone operating system platforms include Symbian OS, the Blackberry OS, iOS (used by the Apple iPhone and iPad devices), Android, and the Windows Phone OS. Depending upon the device and operating system, third-party applications (commonly termed ‘apps’) may be widely available for download and installation, or may be available from device and/or OS specific services.

With the computing power and a built-in high resolution camera, a modern smartphone can capture images and process these images for various purposes. For instance, the smartphone can perform a face authentication process on a photographed image by identifying the face of which of persons registered in advance the face of a person present in the photographed image corresponds to. To achieve the facial recognition, the smartphone can use various image recognition techniques, such as performing face detection for extracting an image corresponding to a face part of a person from each of photographed images, comparing the detected image corresponding to the face part with each of a plurality of face images registered in advance, and searching the face image a matching degree of which is equal to or higher than a standard.

In another example, a computing device can extract a user's desired image from a scene of a sport picture of, for example, tennis, such as “successful passing shot” and “successful smash”. Such methods include methods of recognizing the substance of such an image by recognizing a “successful passing shot” section, a “successful smash” section and a like section of picture information one by one, or by extracting positions of respective of a ball, players and court lines and totally judging a change with time in spatial correlations among the extracted positions by the computing device.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an example process of reproducing the accurate color representation.

FIG. 2 illustrates an example process of identifying an accurate paint swatch number.

FIG. 3 is a high-level block diagram showing an example of the architecture of a computer device, which may represent computer device for running an application.

### DETAILED DESCRIPTION

References in this description to “an embodiment”, “one embodiment”, or the like, mean that the particular feature, function, or characteristic being described is included in at least one embodiment of the present invention. Occurrences of such phrases in this description do not necessarily all refer to the same embodiment, nor are they necessarily mutually exclusive.

Technology for reproducing accurate paint color representation that does not exist in the originally captured digital images. The method retrieves a computerized color representation of a paint color of interest, which is collected by a camera/device model under a controlled lighting condition with a known intensity. The method captures a digital image using the same or similar camera/device model and analyzes the color space and the pixel intensities of the image into a relational function, e.g. in Hue, Saturation and Value (HSV) space. The method further applies the computerized color representation with the known intensity of the paint color of interest, to the relational function, in order to generate a paint color representation adjusted by an ambient light condition from the image. The method then reproduces the light condition adjusted paint color representation on at least a portion of the digital image.

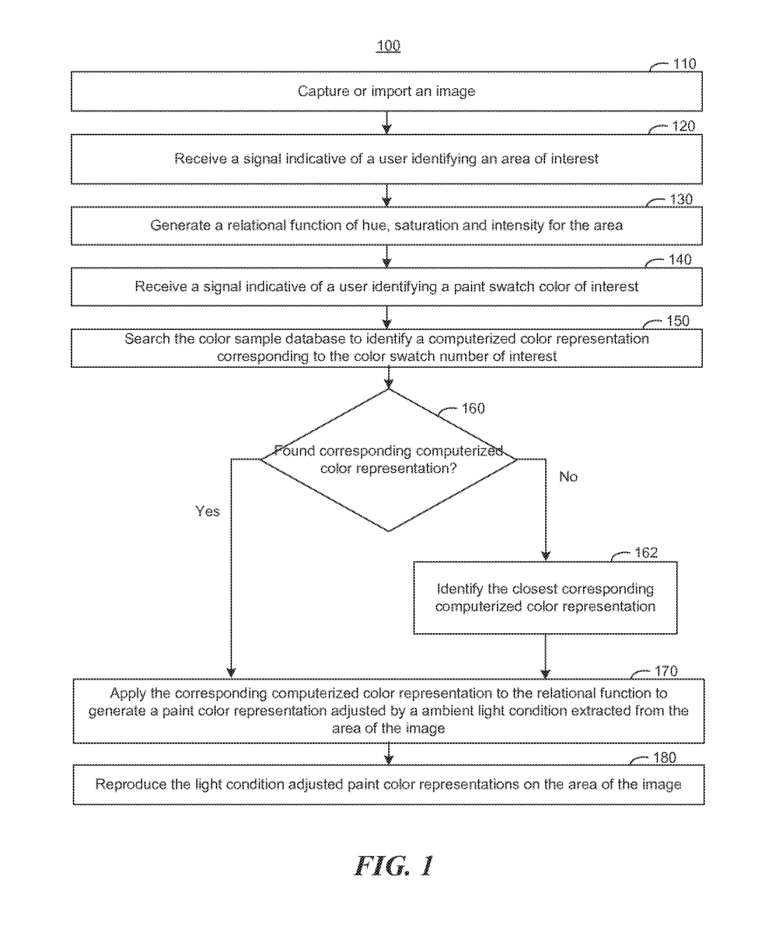

According to at least one embodiment, a computer implemented application for reproducing accurate color representation to an image based on a paint swatch number is provided. FIG. 1 illustrates an example process of reproducing the accurate color representation as disclosed herein. The application captures or imports an image, allows a user to identify an area of interest in the image (e.g. by tapping on the image), and recognizes a paint swatch number matching the selected area. The application recognizes the paint swatch number based on a color sample database. The color sample database was compiled by capturing images of paint color swatches or paint color fans under controlled lighting condition (e.g. a predetermined intensity) using different models of imaging devices, including digital cameras and mobile devices. The database can further normalize the computerized color representations of the paint colors across the different models of imaging devices. The database stores the corresponding relationships between the computerized color representations and the paint color swatch number.

The application analyzes an area within the image, to extract a relation between the hue, saturation and the intensity (i.e. the value in HSV space) on the area. The area represents a real world object captured by the image with a uniformed color in the area. Due to the light condition variation, the area contains different values of computerized color representations (e.g. different hue, saturation, intensity values). The application generates a relational function representing the relation between the hue, saturation and intensity variables for the area.

The application receives a user input regarding a color swatch of interest. The application searches the database to identify a computerized color representation corresponding to the color swatch number of interest. The application applies the matched computerized color representation from the database to the relational function to generate a paint color representation adjusted by an ambient light condition extracted from the area of the image. The application then reproduces the light condition adjusted paint color representations on the area of the image.

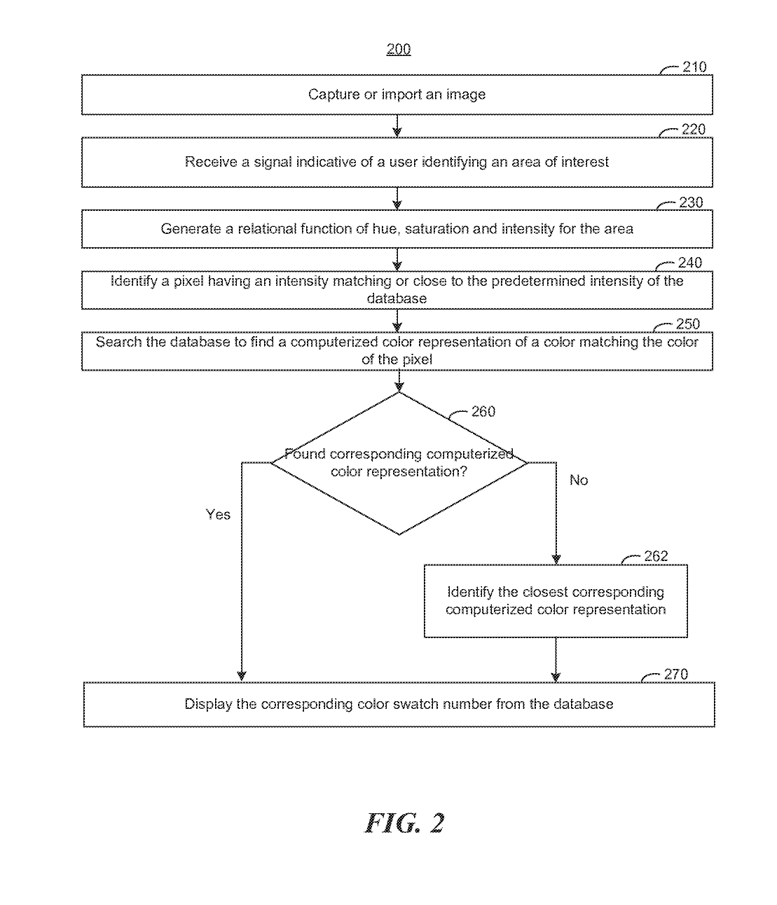

According to another embodiment, a computer implemented application for identifying an accurate paint swatch number from an image is provided. FIG. 2 illustrates an example process of identifying an accurate paint swatch number as disclosed herein. The application captures an image and identifies an area of interest similarly as to the previous embodiment. The application analyzes the image and generates a relational function representing the relation between the hue, saturation and intensity variables for the area. The application identifies a pixel having an intensity matching or close to the predetermined intensity of the database.

The application searches the database to find a computerized color representation of a color matching or closest to the color of the pixel (e.g. based on the hue values). Once the matched color is found, the application notifies the user of the matching color swatch by displaying the corresponding color swatch number from the database. In case that there is no extract matching, the application can suggest the closest color swatch and generates a synthesized image showing the suggested closest color in ambient light condition in a way similar to the process illustrated in FIG. 1.

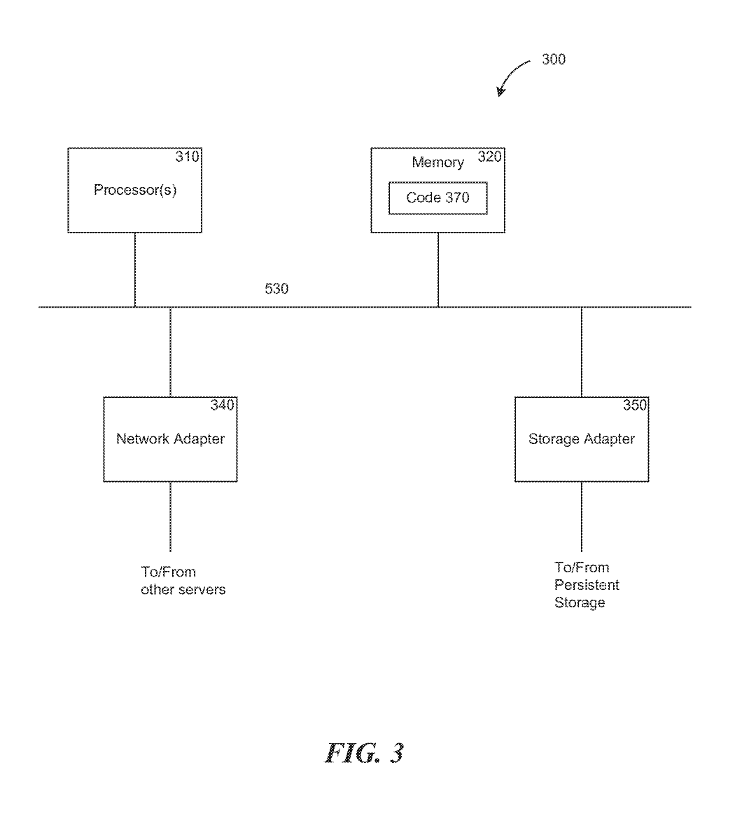

FIG. 3 is a high-level block diagram showing an example of the architecture of a computer device 300, which may represent computer device for running the application. The device 300 includes one or more processors 310 and memory 320 coupled to an interconnect 330. The interconnect 330 shown in FIG. 3 is an abstraction that represents any one or more separate physical buses, point to point connections, or both connected by appropriate bridges, adapters, or controllers. The interconnect 330, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 310 is/are the central processing unit (CPU) of the device 300 and, thus, control the overall operation of the device 300. In certain embodiments, the processor(s) 310 accomplish this by executing software or firmware stored in memory 320. The processor(s) 310 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 320 is or includes the main memory of the device 300. The memory 320 represents any form of random access memory (RAM), read-only memory (ROM), flash memory, or the like, or a combination of such devices. In use, the memory 320 may contain, among other things, code 370 embodying at least a portion of an operating system of the device 300. Code 370 may also include instructions for executing the techniques disclosed herein.

Also connected to the processor(s) 310 through the interconnect 330 are a network adapter 340 and a storage adapter 350. The network adapter 340 provides the device 300 with the ability to communicate with devices, such as other user devices, network servers, cloud servers, or database servers, over a network and may be, for example, an Ethernet adapter or Fibre Channel adapter. The storage adapter 350 allows the device 300 to access a persistent storage, and may be, for example, a Fibre Channel adapter or SCSI adapter.

The code 370 stored in memory 320 may be implemented as software and/or firmware to program the processor(s) 310 to carry out actions described below. In certain embodiments, such software or firmware may be initially provided to the device 300 by downloading it from a system through the device 300 (e.g., via network adapter 340).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A method, comprising:
receiving, at a computing device, a signal indicative of a user identifying an area of interest in an image;
generating a relational function of hue, saturation and intensity for the area of interest in the image;
receiving a signal indicating of the user identifying a paint color swatch number of interest;
searching a color sample database trying to identify a computerized color representation corresponding to the paint color swatch number of interest;
identifying a computerized color representation closely corresponding to the paint color swatch number of interest;
applying the identified computerized color representation to the relational function to generate a paint color representation adjusted by an ambient light condition extracted from the area of interest in the image; and
reproducing the paint color representation adjusted by the ambient light condition on the area of interest in the image.
